(19) United States
(12) Patent Application Publication
(10) Pub. No.: US 2009/0261278 A1
(43) Pub. Date: Oct. 22, 2009

(54) Apparatus for Controlling Fluid Flow

(76) Inventors: Trevor Murphy, Queensland (AU); Ken Harrison, Queensland (AU)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 12/441,201

(22) PCT Filed: Sep. 14, 2007
(86) PCT No.: PCT/AU2007/001368

§ 371 Date: Mar. 13, 2009

(30) Foreign Application Priority Data
Sep. 15, 2006 (AU) 2006905111

(51) Int. Cl. F16K 21/16; F16K 21/06

(52) U.S. Cl. 251/50; 137/505

(57) ABSTRACT

An apparatus for controlling fluid flow comprising a main chamber having an inlet and an outlet, a control member movable between a start position where the outlet is open and a finish position where the outlet is at least partially closed, an urging means for urging the control member to the start position and trickle means for allowing a trickle of fluid to exit the outlet when the control member is in the finish position.

### FIELD OF THE INVENTION

The present invention relates to water conservation and it's particularly applicable to domestic water consumption.

### BACKGROUND OF THE INVENTION

According to one application the invention relates to a device or apparatus for controlling water delivered from a water outlet such as a tap or shower fitting.

In countries such as Australia where droughts are a regular part of the climate in many regions, water management and in particular water conservation is particularly important.

In a typical domestic situation, water is delivered from a central provincial authority and water consumption is measured by a water meter. In times of drought however even though there may be water restrictions it is difficult for the occupants of houses to monitor their water consumption.

If it is desired to control the amount of water used for irrigating a garden there are devices incorporating a valve with a timer switch which can be controlled to switch off water supply after a desired amount of time. Such devices although useful do not give any indication as to the amount of water which is delivered for the period of time. Furthermore there is no readily available device which can be used inside the house for monitoring the amount of water usage.

One type of timer valve is disclosed in U.S. Pat. No. 5,348,269. This patent provides a device configured to provide timed flow, based upon back flow pressure flowing from a flow piece via a back flow port. Over a period of time a piston is moved to the end of a housing until an outlet port is enveloped and sealed by a front end of the piston. A spring urges the piston back to its starting position.

The present invention provides an alternative type of device for controlling fluid flow.

### SUMMARY OF THE INVENTION

According to one aspect of the present invention there is provided an apparatus for controlling fluid flow comprising a main chamber having an inlet and an outlet, a control member movable between a start position where the outlet is open and a finish position where the outlet is at least partially closed, an urging means for urging the control member to the start position and trickle means for allowing a trickle of fluid to exit the outlet when the control member is in the finish position.

Preferably the apparatus includes a reset means for allowing the urging means to move the control member to the start position.

The control member may include any member which is movable under fluid pressure.

Preferably the control member includes a plurality of components.

Preferably the control member comprises a piston.

The piston may includes a disk member.

According to one embodiment the apparatus includes a drive means which is driven by fluid flow through the inlet.

The drive means may be adapted to move the piston to the finish position after a predetermined period of time.

The drive means may comprise a gear assembly.

Preferably the gear assembly comprises a plurality of gear wheels.

According to one embodiment the gear assembly comprises a drive gear wheel for moving the piston.

The drive means may comprise an axle shaft on which the gear wheels are mounted.

The drive means may comprise a timer for moving the piston after a predetermined period of time.

Preferably the drive means comprises a controller for moving the piston after a predetermined volume of fluid has passed through the inlet.

The gear assembly may be substantially similar to that used in a water meter.

Preferably the drive means comprises a plurality of gear wheels mounted on a shaft with a first gear wheel engagable by a drive member mounted on the shaft and axially movable with respect to the shaft.

The drive member preferably rotates according to the flow rate of fluid through the inlet.

The drive member may engage the first gear wheel.

Preferably the drive member comprises a cone portion.

The drive member may be connected to a drive shaft which is adapted to spin in accordance with water flow through the inlet.

The drive shaft may have a proximal (inlet) end which couples with a flow piston which rotates when experiencing an axial flow of water.

The flow piston may couple with a working chamber component.

Preferably the drive shaft fits through a top plate which covers the working chamber component.

The drive shaft may have a coupling head which engages and drives the drive member.

The drive member may be urged towards the inlet end of the apparatus by another urging means such as a spring.

It is preferred that the urging means is mounted on the axle.

The piston may comprise a stopper or valve for at least partially closing the outlet.

The piston preferably comprises a wheel mounted on the shaft and having an axial protrusion engagable by an engagement part of the last gear wheel.

The engagement part preferably comprises an axial wall or protrusion on a distal surface thereof.

Preferably the apparatus includes a centering means for returning the piston to the original angular position with respect to the last gear wheel when a reset means is activated.

Preferably the reset means comprises a trigger for allowing the urging means to urge the piston back to its start position when fluid pressure is removed from the inlet.

The centering means may comprise a spring.

The gear assembly may include a control arm having controlling gear wheels for controlling the gear wheels on the axle.

The gear assembly may include any device in which successive gear wheels rotate incrementally when an immediately adjacent preceding gear wheel has rotated 360°.

The control arm comprises a plurality of control levers, one for each gear wheel on the axle.

Each gear wheel on the axle may comprise gear teeth concentrically arranged around the centre on a proximal edge or face for engagement with the gear teeth of one control gear wheel.

The gear wheel on the axle preferably comprises an engageable recess/projection on its distal edge or face for engagement with the teeth of one control gear wheel.

The apparatus may comprise a main housing with an inlet connector for connection to a conduit.

The main housing preferably comprises an outlet connector for connection to a shower head.

According to one embodiment the main housing fits between a shower head and connecting pipework.

The inlet connector and/or outlet connector may have a screw thread.

The housing preferably comprises an inlet piston chamber in the main chamber with the inlet chamber separated from a piston chamber by an inlet chamber partition with at least one opening allowing flow of fluid from the inlet to the piston chamber.

The apparatus preferably comprises inlet chamber walls.

The inlet chamber walls may comprise a partition wall separating the inlet chamber from the piston chamber.

The piston preferably comprises a cylindrical member with side walls which slide over side walls of the inlet chamber walls.

Preferably at least one hole/opening extends through the partition wall to allow fluid flow between the inlet chamber and piston chamber.

According to one embodiment the piston comprises a central spigot or protrusion on its outer top surface (surface opposite the outlet).

The inlet chamber walls may comprise inner and outer peripheral walls defining an annular chamber therebetween.

At least one passage may extend through the inner and outer peripheral walls.

Preferably the partition wall has at least one passage between the piston chamber and annular chamber.

According to one embodiment the piston includes a closure member for at least partially closing the outlet.

The closure member may be located substantially on the outer top surface of the piston.

It is preferred that the apparatus includes an indicator for indicating when a set volume of water has been delivered through the exit.

Preferably the indicator includes an electronic timer.

According to one embodiment the indicator comprises an alarm means for indicating that a predetermined volume of water has almost passed through the exit.

Preferably the indicator comprises a mechanism for rapidly reducing the flow of water through the exit when a predetermined volume of water has passed through the exit.

Preferably the indicator comprises a valve which rapidly reduces the amount of water which is able to pass through the exit once a predetermined volume of water has passed through the exit.

According to one embodiment the apparatus comprises an automatic reset function.

Preferably the automatic reset function is only able to be activated by cutting off water to the inlet of the apparatus.

### BRIEF DESCRIPTION OF THE DRAWINGS

Preferred embodiments of the present invention will now be described by way of example only with reference to the accompanying drawings in which:

FIG. 1 shows a cross-sectional side view of a flow control apparatus according to a first embodiment of the invention;

FIG. 2 shows a cross-sectional side view of an apparatus for controlling fluid flow according to a second embodiment of the present invention;

FIG. 3 shows a disassembled view of the apparatus shown in FIG. 2;

FIG. 4a shows a top view of part of the apparatus shown in FIG. 3;

FIG. 4b shows an angled view of part of the apparatus shown in FIG. 4a;

FIG. 4c shows an end view of the part of the apparatus shown in FIG. 4b.

### DETAILED DESCRIPTION OF THE DRAWINGS

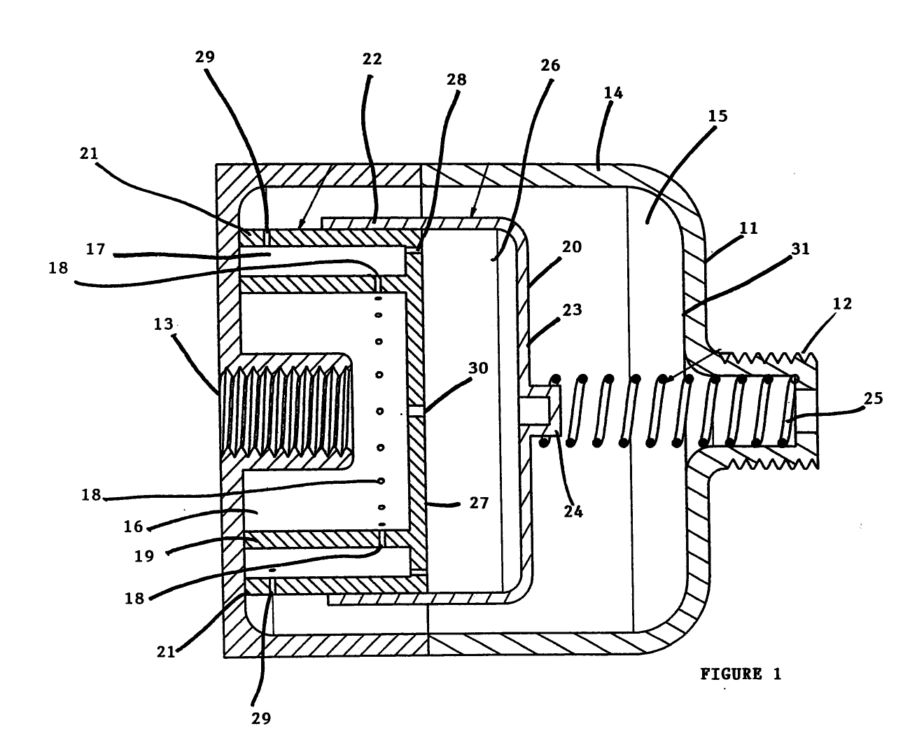

The device 11 shown in FIG. 1 is able to deliver a fixed volume of fluid such as water through an outlet 12 from an inlet 13 before fluid flow through the outlet is dramatically decreased. The result is a trickle of water running through the outlet 12. When the device 11 is fixed to an outlet for a shower nozzle, and the tap is turned on, a fixed volume is delivered by the device and water flow is then effectively cut off to provide just a trickle of water through the outlet. By turning the tap off and turning it back on again the device automatically resets and another volume of water can be delivered through the shower outlet before water flow is reduced to a trickle.

As shown in FIG. 1 the device 11 consists of a generally cylindrical housing 14 with a main internal chamber 15.

A cylindrical inlet chamber 16 is provided around the inlet 13 and this is also provided with an annular peripheral chamber 17 around its periphery. A series of peripheral openings or passages 18 are provided through the peripheral cylindrical wall 19 of chamber 16 and provide fluid communication between chamber 16 and chamber 17.

A cylindrical piston 20 is located over the outer peripheral wall 21 of annular chamber 17. The piston 20 accordingly is open at its inlet end 22 and acts as a sleeve which is able to slide over the external peripheral wall of wall 21. Its outlet end 23 is closed and provided with a central spigot 24 which serves two purposes. One of these is to locate one end of a spring 25 and the other is to fit into outlet 12 as a stopper so as to partially close it.

A piston chamber 26 is created between piston 20 and a flat partition wall 27 of the cylindrical inlet chamber 16 and chamber 17. One or more interconnecting passages 30 pass through wall 27 interconnecting passages 16 and 26. Furthermore, additional passages 28 interconnect chamber 17 and chamber 26.

The spring 25 in its equilibrium position is located at one end inside the outlet 12 and at the other end extends around the central spigot 24 and forces the piston 20 to contact wall 27. Thus effectively eliminating chamber 36. It should be noted however that other embodiments of the invention envisage chamber 26 initially having a small size so that the wall 23 of piston 20 is not actually in contact with wall 27.

The main chamber 15 is in fluid communication with chamber 17 through passages 29 extending through peripheral wall 21 of chamber 17.

It should be noted that the number and size of each of the passages 19, 28 and 29 may be varied to adjust the rate at which the piston chamber 26 is filled with fluid.

In operation the inlet 13 which comprises a tubular passage with an internal screw thread is screwed onto the end of a bathroom fitting, tap, hose or the like and a tap is turned on to supply fluid pressure.

Fluid entering the inlet 13 enters passage 16 and passes out through passages 18, 28 and 30. The water entering through passage 30 into chamber 26 forces the piston 20 slowly towards the outlet 12. The speed at which the chamber 26 fills and the piston 20 moves depends upon the number of passages between chamber 16 and 27 as well as passages connecting chambers 16 and 26 with annular chamber 17.

Furthermore the size and number of passages 29 also affects the speed of movement of piston 20.

As water slowly fills up chamber 26 and moves piston 20 to the right (as shown in FIG. 1) towards the outlet 12 most of the water passes from chamber 16 to annular chamber 17 and through passages 29 to the main chamber 15 and out through outlet 12.

It is preferred that most of the water entering through inlet 13 passes through the main chamber 15 and out through outlet 12 with minimum reduction in water flow being noticeable. Thus a person having a shower with the device attached to the shower outlet would generally be unaffected by the presence of the device until the predetermined volume of water has been delivered through the outlet 12.

As the piston 20 moves towards the outlet 12 against the force of spring 25 the chamber 26 gets larger. Eventually the piston 20 contacts the inner wall 31 of the outlet end of the device 11 and the spigot 24 cuts off most of the water supplied through the outlet 12. It is thus preferred that the spigot 24 is sized and configured so that a slight trickle of water can still pass through the outlet 12 when the piston 23 has moved as far as it can to the right of the device 11. In this way there is a perceivable cut off in water being delivered through the outlet 12 so that the recipient is aware that an amount of water has already been delivered through the outlet 12 and that additional water if it was delivered would be in excess of what should ideally be used having consideration for water conservation issues.

A reset device may also be provided to cut off water supply to the chamber 26 and thus allow the force of the spring 25 to force the piston 20 back to its starting position.

This triggering device may involve covering the passages 30 and or 28 and opening another passage in the wall of the piston 20.

An alternative method of resetting the device would be to turn off water supply to inlet 13 so as to allow the spring 25 to force the piston 20 back to its original position where the inner wall of wall 23 contacts the outer wall of wall 27 of the inlet chamber 16.

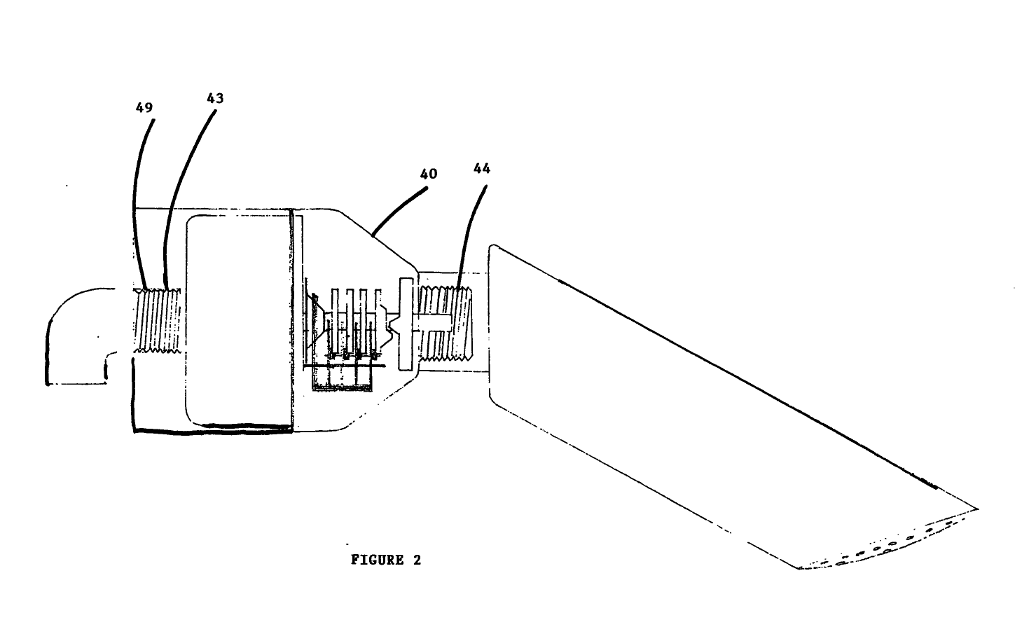

According to another embodiment of the invention a mechanical flow control device can be used to control delivery of a fixed volume of water through an outlet such as a shower nozzle and having the feature shown in FIGS. 2, 3 and 4a to 4c.

As shown in FIG. 2 the device 40 consists of a gearing assembly 41 mounted on a common axle 42 extending between an inlet end 43 and an outlet end 44 of the device 40.

As with the previous embodiment the device 40 is configured to screw onto the end of a tap or pipe and at its outlet end is adapted to have a component such as a shower nozzle screwed onto it.

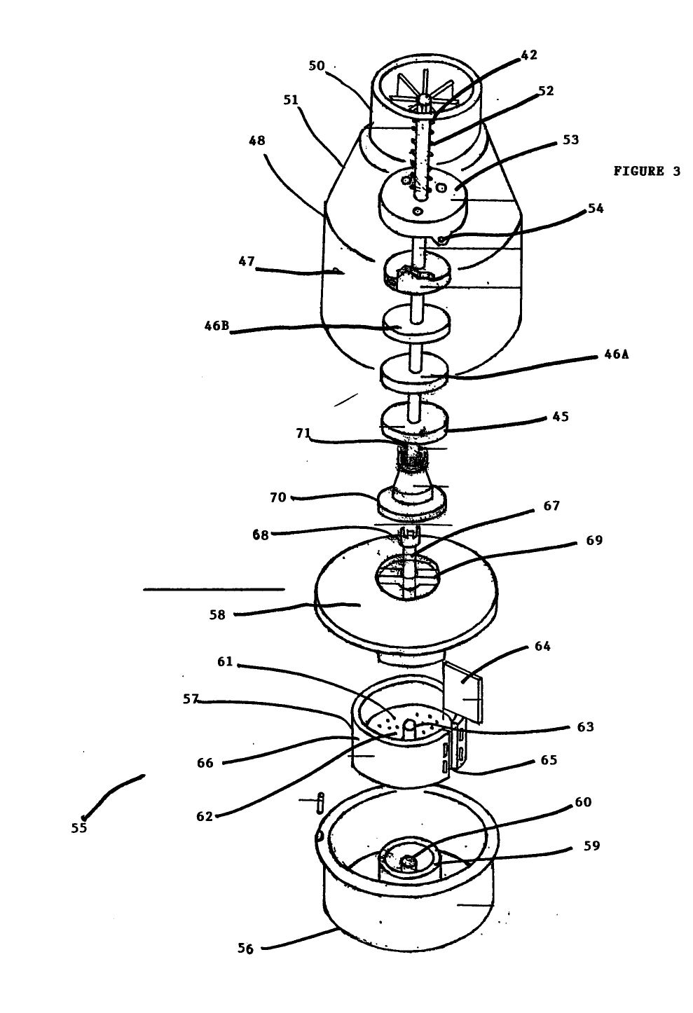

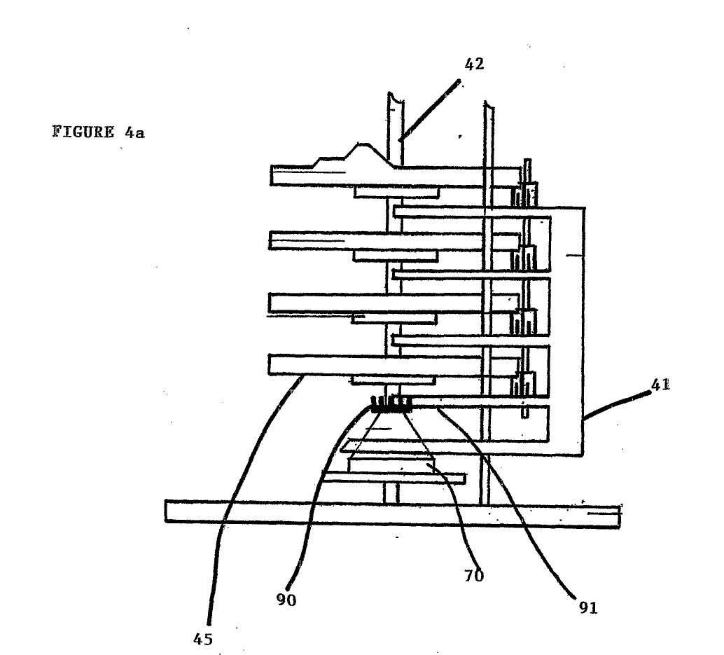

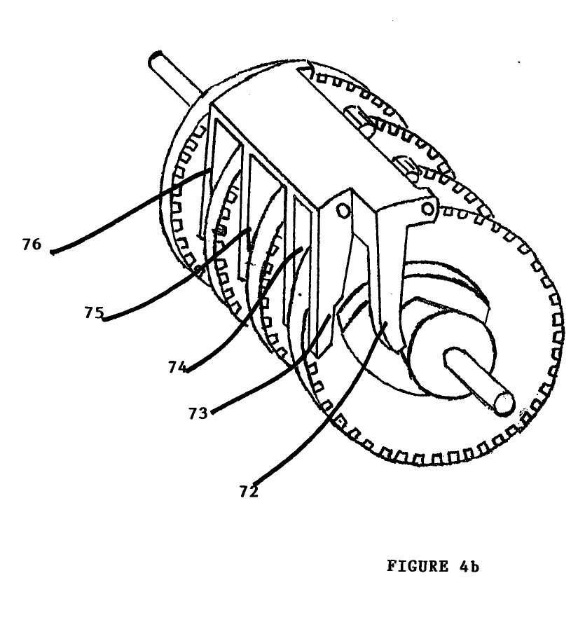

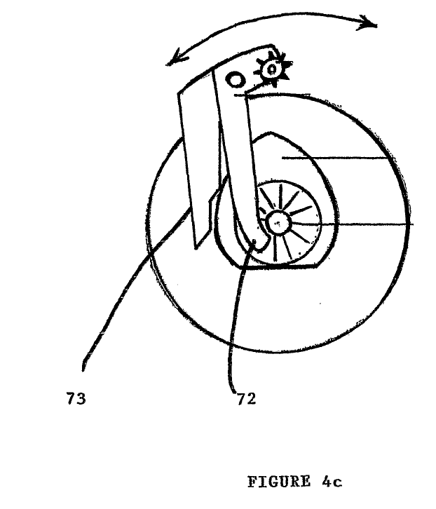

The gearing assembly 41 is somewhat conceptualised in FIG. 3 for ease of understanding. As shown in this Figure the gearing assembly 41 consists of a series of gear wheels starting with a first gear wheel 45, a second gear wheel 46A, a third gear wheel 46B and a final gear wheel 47. These gear wheels are connected to gearing cogs and reset arms which are shown in FIGS. 4a to 4c and discussed later.

The device 40 consists of a tubular housing 48 with a large cylindrical end 49 configured with a screw threaded axially located inlet passage 49. The outlet end 50 of the device 40 consists of a smaller cylindrical section separated from section 48 by a frustoconical reducing section 51.

The axle 42 extends into the outlet 50 and on its outer end is provided with a spring 52 and a stopper 53 which is movable along the axle 42 and is shaped like a wheel with a peripheral axially directed protrusion 54 directed towards the inlet end of the device 40.

The stopper 53 is shaped like a disk or wheel and faces the last gear wheel 47. This gear wheel 47 is configured with a cam surface or equivalent structure which is designed to strike the projection 54 after the last gear wheel 47 has rotated a predetermined distance. This angular movement may be for example 270°.

The gear wheels 45 to 47 operate in accordance with a typical gearing system. For example a 360° rotation of gear wheel 45 is intended to produce an incremental rotational movement of gear wheel 46A. When gear wheel 46A has rotated a full 360° this then produces an incremental rotational movement of the next gear wheel 46B. This in turn incrementally rotates the last gear wheel 47 in the same manner as previously described.

The effect of the above is that the gearing system is effectively a counter which measures a volume of water flowing through the device 40 with a result that the stopper does not move towards the outlet 44 and close it until the final gear wheel 47 is rotated a predetermined angular distance so as to strike projection 54.

At the inlet end of the device 40 fluid such as a water enters through inlet 43 and passes through a rotational flow component 55 consisting of a working chamber 156, a piston 57 and a top plate 58. This component is similar to that used in conventional water meter devices. With the working chamber 56 being a cylindrical bowl-like component with a central circular wall 59 and a central spigot 60 within the centre of this wall.

The piston 57 is also cylindrical with a partition wall generally midway between the ends of the cylinder and with perforations 62 through this partition 61 and a metal central spigot on one side of the partition 61 and a plastic spigot on the other side (not shown). A shutter 64 fits in a peripheral slot 65 extending axially in the peripheral wall 66.

The top plate 58 is circular and disk-like and preferably has a central opening through which is located a control shaft 67 which engages the inlet end of the axle 42. It is also provided with an engagement head 68 which couples with the axle 42.

The inlet end of the shaft 67 is located on the inlet side of the top plate 58 and is provided with one or more radiating blades or fins which are designed to rotate the shaft 67 when water flows through the inlet and strikes it/them.

It is preferred that the or each blade or fin is located within a cylindrical boss on the lower side of the top plate.

According to one embodiment the blade(s) may be in the form of a collar with a radial projection mounted on the lower end of the shaft 67.

The shaft 67 is preferably axially located and held in position by a supporting structure such as webs extending from a cylindrical housing located within a central hole of the top plate.

A reset cone is mounted on the inlet end of the axle 42 adjacent the first gear wheel 45 and is separated from this gear wheel by a spring 71 which urges the reset cone towards the inlet end 43 of the device 40. The small end of the reset cone is provided with a small housing to receive the inlet end of the spring 71.

The larger end of the reset cone 70 is provided with a circular disk which couples with the head section 68 of the shaft 67.

In operation the device 40 is attached to for example a threaded end of a pipe in a shower recess. A tap is turned on water flows through the inlet 43 and into the working chamber 56 through a specially formed opening in a base wall thereof (not shown). Because of the design of this component water flowing axially through the opening in the base wall is induced to flow in a swirling pattern around the cylindrical wall 59. Water then passes through the opening 61 in the piston 60 and the swirling motion of water flow around the central axis of the component 55 results in water striking the blade(s) of the shaft 67 and rotating the shaft 67. Rotational movement of the shaft 67 results in rotational movement of the reset cone 70 which under water pressure behind it moves axially towards the outlet and engages teeth of the gear wheel 45. In this respect the water pressure behind the reset cone 70 is sufficient to overcome the axial force applied by the spring 71.

As the first gear wheel 45 rotates as previously described it incrementally rotates the next gear wheel and so on until the final gear wheel 47 rotates a sufficient distance in order to actuate the stopper 53 to move axially towards the outlet 42 against the force of the spring 52 and substantially close off the outlet 42.

As with the first embodiment it is preferred that the stopper does not completely cut off flow through the outlet 42 but instead provides a trickle of water through the outlet 42.

According to one embodiment water firstly passes through the device 40 so that the reset cone drives the first reduction gear only out of the four reduction gears.

As water passes through the top plate 58 it pushes the reset cone forward which opens a reset mechanism. When the reduction gear 45 has turned through 360° it turns the second gear wheel 46a one tenth of a turn and so on until the final gear wheel 47 is turned one tenth of a turn. Thus the gear reduction ratio is as follows:
gear number 1 turns 1000 times;
gear number 2 turns 100 times
gear number 3 turns 10 times; and
gear number 4 turns 1 time.

When the final gear wheel 47 has turned nine tenths of the 360°, it pushes the stopper 53 forward to reduce water flow a little and in the next one tenth of a turn the gear wheel 47 pushes the water stopper further towards the outlet so as to completely close it or alternatively force it as far as it can go into the outlet but to allow a trickle of water still to pass therethrough.

The amount of water allowed to trickle through the outlet can be determined by making the stopper smaller than the outlet.

As with the first embodiment when taps are turned off it releases pressure on the stopper and allows the spring 52 to push the stopper 53 back to its original position and allows the cone to also be pushed back to its original position by spring 71.

When the reset cone is pushed back to its starting position and thus slides away from the first gear wheel 45 the device effectively resets and the gear wheels can all spin back to their original positions. This is because the engagement section 72 on the end of cone 70 disengages with the teeth of the first wheel 45.

The inlet component 55 which provides the rotational flow of water may be modified as desired. As previously noted the component described is similar to that used in water meters for ease of understanding. Alternative designs of components for inducing a swirling motion of water are also applicable to the present invention.

FIGS. 4a to 4c show one embodiment of the invention for a gearing assembly. In this embodiment reset arms 72, 73, 74 and 75 engage ratchet teeth or cam surfaces of each gear wheel. It is preferred that they operate with the gear reduction principles described by way of example above.

As shown in FIG. 4a the engaging head 90 of the reset cone 70 can clearly be seen engaging with the first cog 91 of the first gear wheel 45.

The first and second embodiments described above outline a hydraulic and mechanical version of the invention. In each case a fixed volume of water can be delivered through an outlet. This enables a clearer indication as to the amount of water used especially if the device is marked with volumetric indications which is a further optional feature of the invention.

According to another embodiment of the present invention an electronic version of the invention consists of an electronic device for sensing the amount of fluid flowing through a conduit or alternatively the time that elapses when fluid flows through a conduit. In each case the electronic sensing device is utilised to measure a volume of water so that when a predetermined volume has been reached an electronically actuated valve is able to be closed to reduce the flow of fluid to a trickle. Hence in relation to a shower application, an electronic flow sensor would detect the flow of water through a water pipe leading to a shower outlet and this sensed data would be relayed to a microprocessor which is able to calculate whether a predetermined volume has passed through the point where the sensor is located. The microprocessor which would be connected to an electrically actuated valve would close the valve when the predetermined volume had been reached. The valve would not completely close so as to provide a trickle of water as an indication of the allowed volume of water being reached.

It is also noted that because the valve does not completely close this reduces potential water hammer problems.

The microprocessor may also be connected to a sensor for sensing the reduction in pressure which occurs when taps are turned off. When such an action is detected the device would be reset/initialised to indicate that a zero volume of liquid/water had been sensed by the sensing device.

According to another embodiment of the present invention the electrical version could be embodied in a single showerhead device incorporating a shower nozzle and a sensor at an inlet of the nozzle which is connected to the end of a water pipe. The microprocessor could be located on an external surface of the shower nozzle in a water proof manner and may be provided with a digital readout to identify volumetric fluid flow.

In addition to the above the device may incorporate a threshold setting function to enable a user to set the threshold level of the volume of water. Hence as an example as restrictions on water use increase the threshold value may be reduced to limit the amount of water that may be delivered through the shower nozzle.

According to another embodiment of the present invention a combination of hydraulic, mechanical and electrical versions of the invention may be utilised.

According to a further embodiment of the present invention an electronic display may be provided on the exterior surface of any version of the device in accordance with the present invention.

It is to be understood that, if any prior art publication is referred to herein, such reference does not constitute an admission that the publication forms a part of the common general knowledge in the art, in Australia or in any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An apparatus for controlling fluid flow comprising a main chamber having an inlet and an outlet, a control member movable between a start position where the outlet is open and a finish position where the outlet is at least partially closed, an urging means for urging the control member to the start position and trickle means for allowing a trickle of fluid to exit the outlet when the control member is in the finish position.

2. The apparatus as claimed in claim 1 including a reset means for allowing the urging means to move the control member to the start position.

3. The apparatus as claimed in claim 1 wherein the control member comprises a piston which includes a disk member.

4. The apparatus as claimed in claim 3 including a drive means which is driven by fluid flow through the inlet and which comprises a gear assembly.

5. (canceled)

6. The apparatus as claimed in claim 4 wherein the drive means comprises a timer for moving the control member after a predetermined period of time.

7. The apparatus as claimed in claim 4 wherein the drive means comprises a controller for moving the control member after a predetermined volume of fluid has passed through the inlet.

8. The apparatus as claimed in claim 6 wherein the drive means comprises a plurality of gear wheels mounted on a shaft with a first gear wheel engageable by a drive member mounted on the shaft and axially moveable with respect to the shaft.

9. The apparatus as claimed in claim 8 wherein the control member comprises a stopper for at least partially closing the outlet.

10. The apparatus as claimed in claim 9 wherein the drive means comprises a plurality of gear wheels mounted on the shaft, the first gear wheel engageable by a drive member mounted on the shaft and axially moveable with respect to the shaft.

11. The apparatus as claimed in claim 10 wherein the control member comprising a wheel mounted on the shaft and having an axial protrusion engageable by an engagement part of a last gear wheel and wherein the engagement part comprises an axial wall or protrusion on a distal surface thereof.

12. (canceled)

13. The apparatus as claimed in claim 11 including a centering means for returning the control member to the original angular position with respect to the last gear wheel when a reset means is activated.

14. The apparatus as claimed in claim 13 wherein the reset means comprises a trigger for allowing the urging means to urge the control member back to its starter position when fluid pressure is removed from the inlet.

15. The apparatus as claimed in claim 13 wherein the centering means comprises a spring.

16. The apparatus as claimed in claim 11, wherein the gear assembly includes a control arm having controlling gear wheels for controlling the gear wheels on the axle.

17. The apparatus as claimed in claim 16 wherein the control arm comprises a plurality of control levers, one for each gear wheel on the axle.

18. The apparatus as claimed in claim 17 wherein each gear wheel on the axle comprises gear teeth concentrically arranged around the centre on a proximal edge for engagement with the gear teeth of one control gear wheel.

19. The apparatus as claimed in claim 18 wherein the gear wheel on the axle comprises an engageable recess on its distal edge or face for engagement with the teeth on one control gear wheel.

20. The apparatus as claimed in claim 1 comprising a main housing with an inlet connector for connection to a conduit.

21. The apparatus as claimed in claim 20 wherein the main housing comprises an outlet connector for connection to a shower head, and further comprises an inlet connector for connection to a screw thread of a pipe.

22. (canceled)

23. The apparatus as claimed in claim 21 wherein the housing comprises an inlet piston chamber in the main chamber with the inlet chamber separated from a piston chamber by an inlet chamber partition with at least one opening allowing flow of fluid from the inlet to the piston chamber.

24. The apparatus as claimed in claim 23 comprising inlet chamber walls including a partition wall separating the inlet chamber from the piston chamber.

25. The apparatus as claimed in claim 24 wherein the control member comprises a piston having a cylindrical member with side walls which slide over side walls of the inlet chamber walls.

26. The apparatus as claimed in claim 25 including least one hole extending through the partition wall to allow fluid flow between the inlet chamber and piston chamber.

27. The apparatus as claimed in claim 1 including an indicator for indicating when a predetermined volume of water has passed through the outlet.

28. The apparatus as claimed in claim 1, wherein the control member comprises an electrically actuated valve.

29. The apparatus as claimed in claim 28, including a sensor for detecting flow of water entering the inlet, and a data processor connected to the sensor and the control member for controlling operating of the control member when a predetermined amount of fluid has passed through the inlet.

30. (canceled)

31. The apparatus as claimed in claim 29, wherein the urging means comprises an electrical motor for driving the electrically actuated valve.

32. (canceled)
